(19) United States
(12) Patent Application Publication
(10) Pub. No.: US 2006/0161718 A1
(43) Pub. Date: Jul. 20, 2006

(54) System and method for a non-uniform crossbar switch plane topology

(76) Inventors: Stuart Allen Berke, Austin, TX (US); Mark Shaw, Garland, TX (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/039,308

(22) Filed: Jan. 20, 2005

(51) Int. Cl. G06F 13/00

(52) U.S. Cl. 710/317

(57) ABSTRACT

A system and method for communicatively coupling a plurality of processor groups residing in a symmetric multiprocessing (SMP) system. One embodiment of a non-uniform crossbar switch plane multiprocessing (SMP) system comprises a plurality of processor groups and a non-uniform crossbar switch plane system comprising a plurality of routes, such that each of the processor groups are coupled to the other processor groups by a number of routes at most equal to (N-1), where N equals the number of processor groups.

### BACKGROUND

Symmetric multiprocessing (SMP) systems employ many parallel-operating central processing units (CPUs) which independently perform tasks under the direction of a single operating system. One type of SMP system is based upon a plurality of CPUs employing high-bandwidth point-to-point links (rather than a conventional shared-bus architecture) to provide direct connectivity between the CPU and to router devices, input/output (I/O) devices, memory units and/or other CPUs.

During fabrication, clusters of processors, such as CPUs, may be fabricated onto a single unit or die for convenience and efficiency. The clusters are communicatively coupled together via router devices, such as a crossbar, to facilitate communications among the CPUs and other components, such as input/output (I/O) devices. A plurality of clusters, crossbars and/or other devices may be assembled onto modular boards or onto a chassis to create a large SMP system having many CPUs.

As the size of conventional SMP systems increase, the number of ports, and hence the size of the crossbar, also increases. Larger crossbars may be difficult to fabricate because of the associated large area of silicon required for fabrication and/or because of the large number of high-speed signal pins associated with each port.

As an illustrative example, one type of high-bandwidth point-to-point link uses ten lanes per link. A lane is sometimes referred to as a serializer/deserializer (SERDES) link. Each SERDES link employs four high-speed pins to support bi-directional communications. Thus, a 10-port crossbar would have four hundred high-speed signal pins (10 ports×10 lanes/port×4 pins/lane=400 pins). If the architecture employed twenty (20) lanes per port, the number of high-speed signal pins increases to eight hundred (800).

A 12-port crossbar having 10 lanes per port architecture employs 480 high-speed signal pins. If the architecture employs 20 lanes per port, the number of high-speed signal pins increases to 960.

Fabrication of the above-described 10-port and 12-port crossbars is technically feasible with today's technology. However, at some point, the number of ports that can be fabricated into a single crossbar will eventually become impractical. For example, a 20-port crossbar having 10 lanes per port requires 800 high-speed signal pins. If the architecture employs 20 lanes per port, the number of high-speed signal pins increases to 1600. The difficulty of fabricating, and then coupling, a 20-port or greater crossbar to other devices, at some point becomes impossible. Even with improvements in fabrication and connectivity assemblies, there will always be a practical port size limit to crossbars.

Furthermore, larger crossbars are relatively more expensive to fabricate than smaller crossbars because of the associated large area of silicon required for fabrication, and because of the inherent failure rates associated with large integrated circuits on a single die. Smaller chip areas have a lower per unit percentage failure rate compared to larger chip areas. Die area of a crossbar, with today's fabrication technologies, increases approximately by the square of the number of ports. For example, a 10 port crossbar is 25% of the die size of a 20-port crossbar. A 12-port crossbar is 36% of the die size of a 20-port crossbar.

Because of the above-described practical limitations which will eventually limit the practical size of a crossbar (as measured by the number of ports), design limitations may be encountered if a desired number of crossbar ports are not available to couple the desired number of SMP processors (and/or other devices). Accordingly, at some point, multiple crossbars will be required as the size of an SMP system increases.

Some SMP topologies are based upon a design criteria which limits SMP CPU-to-CPU connectivity via a single crossbar, referred to herein as a single-hop criteria. That is, a CPU-to-CPU communication occurs over only one intermediary crossbar. Single-hop communications have a relatively low latency (time delay), as compared to multiple-hop communication over a plurality of crossbars.

When the number of CPUs employed in an SMP exceeds the number of available ports in a crossbar, then a plurality of crossbars must be employed to provide the desired connectivity between CPUs. Accordingly, the single-hop criteria can not be met for all of the CPUs, and multiple-hops over multiple crossbars will be required for at least some of the SMP CPUs.

FIG. 1A illustrates an exemplary crossbar topology permitting connectivity between 16 CPUs using a 20-port crossbar 102. Sixteen of the available 20 ports provide for CPU-to-CPU connectivity (links 104). Four of the remaining ports provide connectivity to input/output (I/O) devices (links 106.

However, if 20-port crossbars are not available, or not economic to use, two 16-port cross bars 108 may be configured to communicatively couple the 16 CPUs. FIG. 1B illustrates an exemplary crossbar topology permitting connectivity between 16 CPUs using two 16-port crossbars 108. Eight of the available 16 ports provide for CPU-to-CPU connectivity on each 16 ports (links 104). Two of the remaining ports provide connectivity to I/O devices, thus allowing connectivity to 4 I/O devices (links 106, like the above-described 20-port crossbar example). Six ports of each crossbar are used for crossbar-to-crossbar coupling (links 110).

When compared to the 20-port crossbar example of FIG. 1A, the two 16-port crossbar topology of FIG. 1B illustrates two aspects of multiple crossbar topologies. First, half of the CPUs are separated from each other by the two 16-port crossbars 108. Thus, approximately half of the CPU-to-CPU communications may be using two hops. Time delays in CPU-to-CPU communications result because of the latency, or time delay, associated with multiple hops.

Second, because there are only six crossbar-to-crossbar couplings (links 110), traffic congestion may be experienced in the event that more than six CPUs coupled to one of the 16-port crossbars 108 are attempting to communicate with CPUs coupled to the other crossbar. Accordingly, if all six paths (links 110) are currently in use, other CPUs must wait until a crossbar-to-crossbar path becomes available (such as when the CPUs using a crossbar-to-crossbar path complete their communications). Time delays in CPU-to-CPU communications result.

In other situations, such as when more than 16 CPUs are employed by the SMP and/or if 16-port crossbars are not used, more than two crossbars may be employed. FIG. 1C illustrates an exemplary 12-port crossbar topology permitting connectivity between 18 CPUs using three 12-port crossbars 112. Six of the available ports provide for CPU-to-CPU connectivity on each 12-port crossbar (links 104) with this exemplary topology. Two of the remaining ports provide connectivity to I/O devices, thus allowing connectivity to 6 I/O devices (links 106. Two ports of each 12-port crossbar 112 are used for crossbar-to-crossbar coupling (links 110, two ports between each crossbar).

The three 12-port crossbar topology of FIG. 1B further illustrates the above-described aspects of multiple crossbar topologies. First, two thirds of the CPUs are separated from each other by two of the 12-port crossbars 112. Thus, approximately two thirds of the CPU-to-CPU communications may be using two hops. Furthermore, instances may occur when one of the CPUs are communicating to another CPU via three of the crossbars (thus becoming subject to a three-hop communication latency). Accordingly, an even greater overall time delay in CPU-to-CPU communications result (as compared to the two crossbar topology of FIG. 1B).

Second, because there are only two crossbar-to-crossbar couplings (links 110) between the 12-port crossbars 112, even greater traffic congestion may be experienced in the event that more than four CPUs coupled to one of the 12-port crossbar 112 are attempting to communicate with CPUs coupled to the other crossbars. Accordingly, if all four paths (links 110) are currently in use, other CPUs must wait until a crossbar-to-crossbar path becomes available (such as when the CPUs using a crossbar-to-crossbar path complete their communications). Accordingly, an even greater overall time delay in CPU-to-CPU communications result (as compared to the two crossbar topology of FIG. 1B).

If an SMP system employs crossbars having smaller crossbars (fewer ports) and/or employs greater number of CPUs, even more crossbars will be employed. Thus, greater overall time delay in CPU-to-CPU communications will result due to the latency induced by multiple hops across the crossbars and/or increased traffic congestion.

In the above-described examples of conventional multi-crossbar topologies, system processing speed may slow down as CPUs wait for availability of routes through the multiple crossbars during instances of traffic congestion and/or when communications occur over multiple crossbars (experiencing additional latency due to multiple hops). Accordingly, it is desirable to provide single-hop connectivity between the CPUs of an SMP system when multiple crossbars are employed.

### SUMMARY

One embodiment of a non-uniform crossbar switch plane multiprocessing (SMP) system comprises a plurality of processor groups and a non-uniform crossbar switch plane system comprising a plurality of routes, such that each of the processor groups are coupled to the other processor groups by a number of routes at most equal to (N-1), where N equals the number of processor groups.

Another embodiment is a method for processor-to-processor communications in a symmetric multiprocessing (SMP) system having a plurality of processor groups, comprising communicating between a first processor of a first processor group and a second processor of a second processor group over a first route, the first route comprised of a first crossbar and at least communication links coupled to the first processor and the second processor, the communicating occurring when the first route is available; and communicating between the first processor and the second processor over a second route, the second route comprised of a second crossbar and at least other communication links coupled to the first processor and the second processor, the communicating occurring when the first route is not available, wherein each of the processor groups are coupled to the other processor groups by a number of routes at most equal to (N-1), where N equals the number of processor groups.

Another embodiment is a non-uniform crossbar switch plane system, comprising a plurality of crossbars; a plurality of processor groups; a plurality of link paths, one link path communicatively coupling one of the processor groups uniquely with one of the crossbars; and a plurality of routes, each route comprising of one of the crossbars and two of the link paths coupled to that crossbar, such that the processor groups associated with the two link paths are communicatively coupled together, wherein each of the processor groups are coupled to the other processor groups by a number of routes at most equal to (N-1), where N equals the number of processor groups.

### BRIEF DESCRIPTION OF THE DRAWINGS

The components in the drawings are not necessarily to scale relative to each other. Like reference numerals designate corresponding parts throughout the several views.

FIGS. 1A-C are block diagrams illustrating conventional symmetric multiprocessing (SMP) system crossbar topologies.

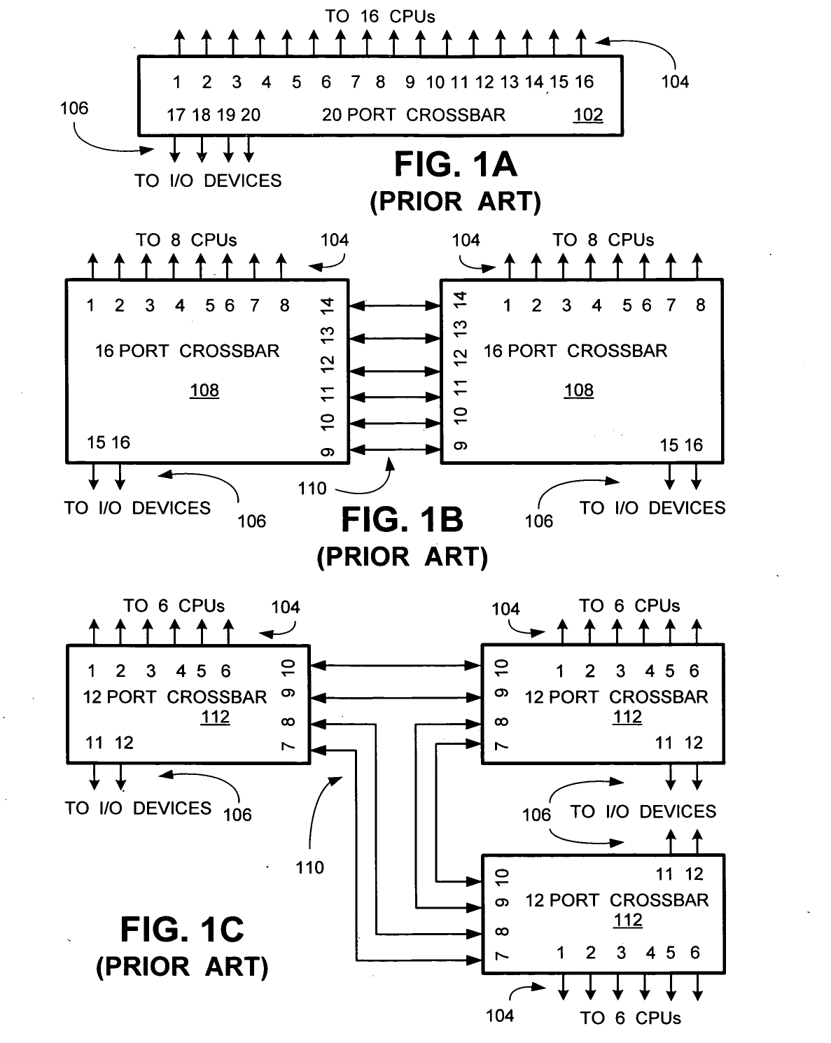

FIG. 2 is a block diagram illustrating an embodiment of a non-uniform crossbar switch plane symmetric multiprocessing (SMP) system.

FIG. 3 is a block diagram of the exemplary embodiment of the SMP system of FIG. 2 illustrating link paths between processor clusters via a crossbar network.

FIG. 4 is a block diagram of an exemplary uniform switch plane SMP system.

FIG. 5 is a block diagram illustrating greater detail of the exemplary embodiment of the non-uniform switch plane SMP system of FIG. 3 having sixteen processors and four 12-port crossbars.

FIG. 6 is a block diagram illustrating greater detail of the exemplary embodiment of a non-uniform switch plane SMP system of FIGS. 3 and 5.

FIG. 7 is a block diagram illustrating selected detail of an alternative embodiment of a non-uniform switch plane SMP system.

FIG. 8 is a block diagram of a portion of an alternative embodiment of an SMP system illustrating an N-port crossbar that provides for additional links for communicatively coupling to input/output (I/O) devices and/or to other crossbars.

FIG. 9 is a flowchart illustrating an embodiment of a process for processor-to-processor communications in a symmetric multiprocessing (SMP) system having a plurality of processor groups.

### DETAILED DESCRIPTION

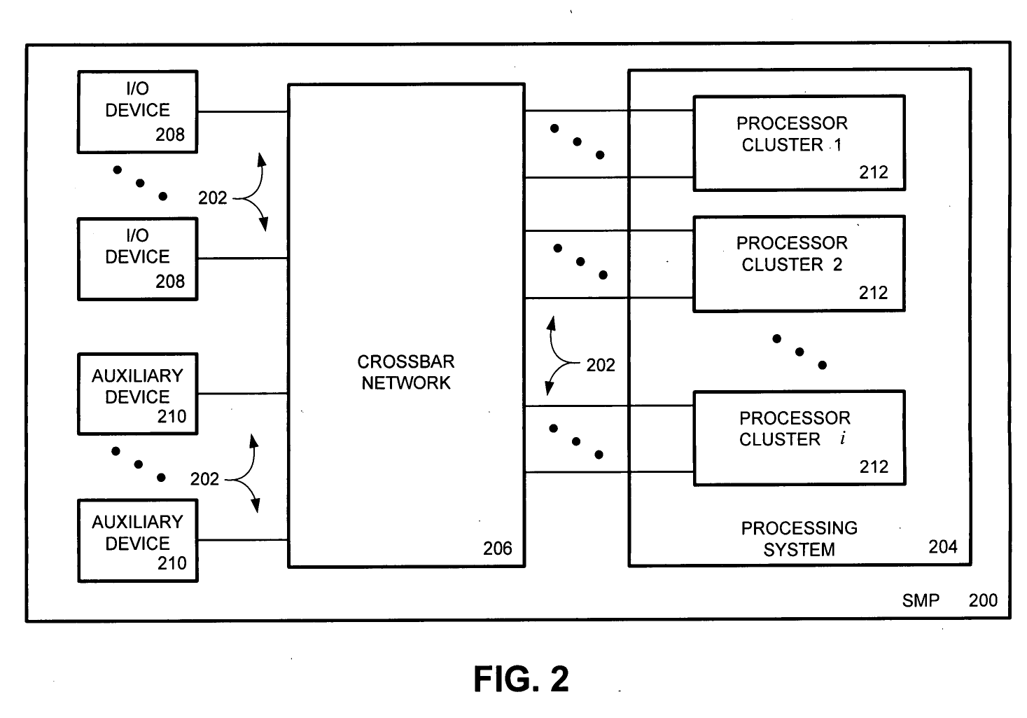

FIG. 2 is a block diagram illustrating an embodiment of a non-uniform crossbar switch plane symmetric multiprocessing (SMP) system 200. The non-uniform crossbar switch plane SMP system 200 may employ many parallel-operating processing units which independently perform tasks under the direction of a single operating system. One embodiment of SMP system 200 is based upon a plurality of processing units employing high-bandwidth point-to-point links 202 (rather than a conventional shared-bus architecture) to provide direct connectivity between the processing units and to input/output (I/O) devices, memory units and/or other processors.

SMP system 200 employs a processing system 204, a crossbar network 206, an optional plurality of input/output devices 208, and an optional plurality of auxiliary devices 210. Processing system 204 comprises a plurality of processor clusters 212, described in greater detail below. I/O devices 208 may be devices for inputting or outputting information to another device or to a user, or may be suitable interfaces to such devices. Auxiliary devices 210 are other types of devices used in the SMP system 200 that may be also coupled to the crossbar network 206, via links 202. Examples of an auxiliary device 210 may include, but are not limited to, a memory device, a controller or a multi-component system. Crossbar network 206 comprises a plurality of crossbars, described in greater detail below, which communicatively couple the above-described components via links 202 under a single-hop design criteria.

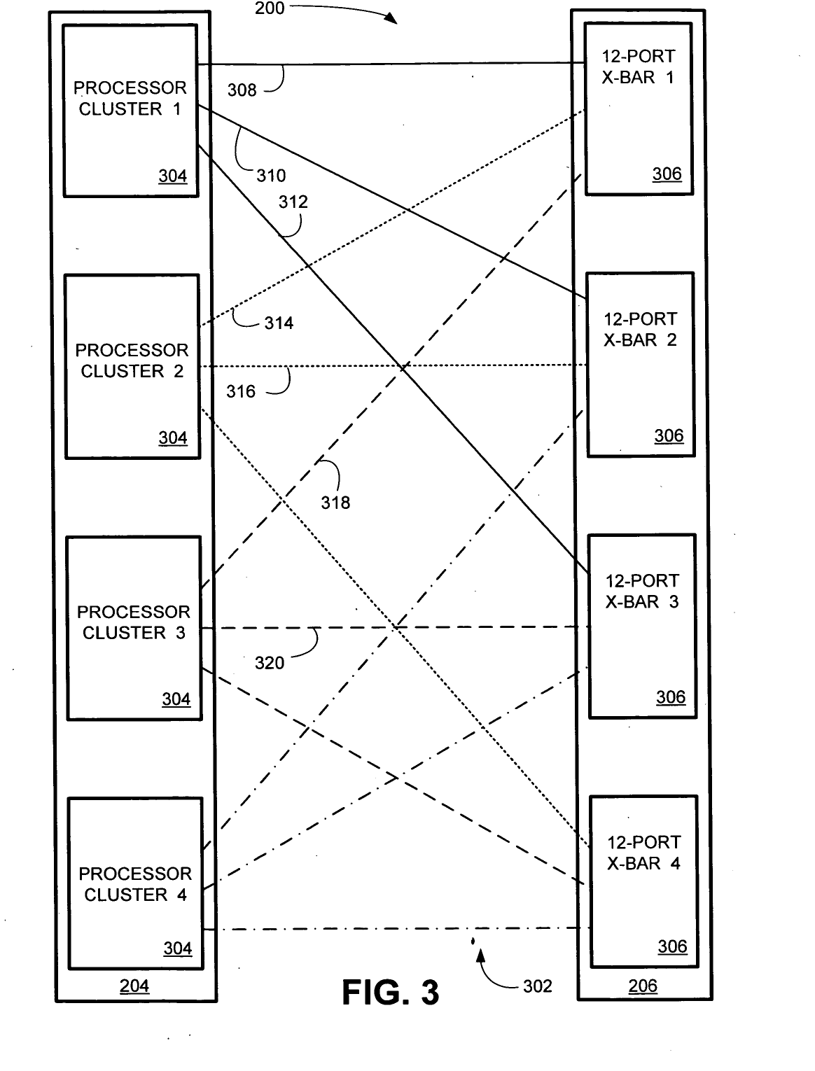

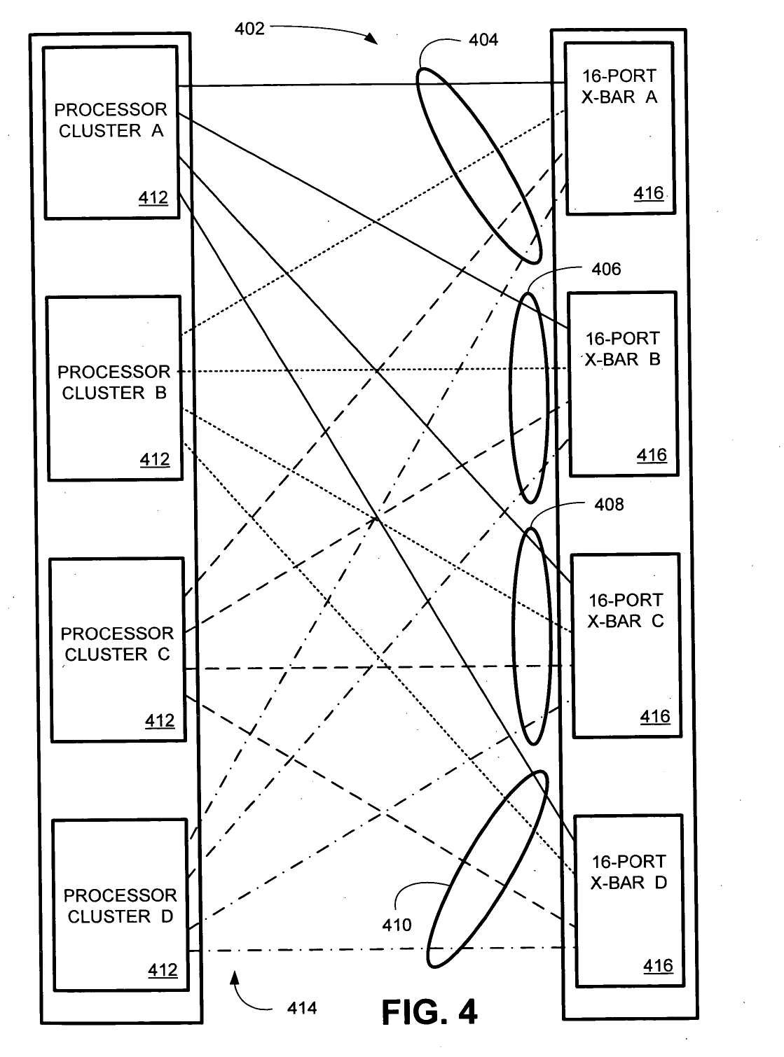

FIG. 3 is a block diagram of the exemplary embodiment of the SMP system 200 illustrating link paths 302 between processor clusters 304 via the crossbar network 206. A link path 302 generally denotes the plurality of high-bandwidth point-to-point links coupling the processors (described in greater below and illustrated in FIG. 4, and which may be referred to hereinbelow as communication links or as links) of a processor cluster 304 to one of the 12-port crossbars 306 (X-bar) of the crossbar network 206. In this illustrative embodiment of SMP system 200, four processor clusters 304 are illustrated (1-4). Each of the processors in a processor cluster 304 are coupled to another one of the processor clusters 304 via link paths 302.

With this illustrative embodiment, twelve link paths 302 link each of the processors in a processor cluster 304 with the processors or other clusters under a single-hop criteria. That is, processor-to-processor communications occur via a single route through a crossbar 306. For example, processor cluster 1 is coupled to crossbar 1 via link path 308. Similarly, processor cluster 1 is coupled to crossbar 2 via link path 310 and to crossbar 3 via link path 312. When the processors of cluster 1 need to communicate to the processors of cluster 2, then crossbars 1 or 2 may be used to communicatively couple the processors. For example, a processor in cluster 1 may communicate to a processor in cluster 2 via the route corresponding to link 308, crossbar 1 and link 314. Alternatively, the processors may communicate via the route corresponding to link 310, crossbar 2 and link 316.

Embodiments providing two (or more) routes between processor clusters provides two important features. First, during possible periods of traffic congestion, at least one alternative route may be available for processor-to-processor communications. SMP processing speed may be maintained by avoiding some instances of traffic congestion. Second, if a link or component associated with a route fails, the SMP system 200 may still operate under a single-hop criteria since at least one alternative route through another crossbar is available.

As described in greater detail below, the number of individual links in a link path 302 depends upon the number of processors in a processor cluster 304. For example, if a processor cluster 304 contains four processors (not shown), then twelve links (4 processors×3 link paths) are required to couple each of the processors to the three crossbars 306. As noted above, a link may itself comprise a plurality of lanes, which themselves may comprise a plurality of individual connections. Thus, a ten lane SMP architecture (assuming 4 connections per lane) would couple to one of the crossbars 306 using 480 connections.

The exemplary embodiment employing the 12-port crossbars 306, under the above-described architecture, would need only 480 high-speed signal pins to accommodate the connections from three processor clusters 304. With this exemplary embodiment, all twelve ports of the 12-port crossbars 306 are used for coupling processors together. If a twenty lane per link architecture is employed, the 12-port crossbars 306 would need only 960 high-speed signal pins to accommodate the connections from three processor clusters 304.

As will be described in greater detail hereinbelow, any number of processors may be grouped into a cluster, also referred to herein as processor groups. Any number of processor clusters may be designed into an SMP system embodiment using a plurality of crossbars under a single-hop design criteria. For example, processors in cluster 1 can establish direct processor-to-processor communications with processors in cluster 3 via a route corresponding to link path 308, crossbar 1 and link path 318, or via a route corresponding to link path 312, crossbar 3 and link path 320. Furthermore, SMP system embodiments may be designed with different sizes of crossbars (referring to the number of ports on a crossbar). The selected crossbar size may be based upon the number of lanes per port, the number of ports selected for CPU-to-CPU connectivity and/or the number of high-speed signal pins. That is, the topology of an SMP embodiment may be based upon any selected N-port crossbar such that the single-hop design criteria is maintained. Furthermore, as will be described in greater detail below, acceptable i^{th} processor bisection bandwidth (BW) may be maintained such that CPU-to-CPU communication traffic congestion is avoided.

FIG. 4 is a block diagram of an exemplary uniform switch plane SMP system 402. To illustrate non-uniform switch planes used by various embodiments of the SMP system 200 (FIGS. 2, 3, 4 and 6), a sixteen-processor SMP system 402 with four switch planes 404, 406, 408 and 410 is illustrated in FIG. 4. Each of the four processor clusters 412 have four processors each (not shown). Link paths 414 are illustrated (rather than individual links) for convenience. Link paths couple the processors of clusters 412 via the 16-port crossbars 416.

Because all possible links between processors are provided in the SMP system 402, this system is a fully-connected, uniform switch plane system topology. This exemplary topology employs four 16-port crossbars 412. This exemplary uniform switchplane topology is subject to other intellectual property interests of the Assignee, and is presented herein to demonstrate various aspects of a non-uniform switch plane SMP system 200 over other novel topologies. Accordingly, the SMP system 402 does not constitute an admission of prior art by the Applicant.

TABLE 1

| Switch | Processor Cluster A | | | | Processor Cluster B | | | | Processor Cluster C | | | | Processor Cluster D | | | |
|---|---|---|---|---|---|---|---|---|---|---|---|---|---|---|---|---|
| Plane | 1 | 2 | 3 | 4 | 5 | 6 | 7 | 8 | 9 | 10 | 11 | 12 | 13 | 14 | 15 | 16 |
| 404 | x | X | x | x | x | x | x | x | x | x | x | x | x | x | x | x |
| 406 | x | X | x | x | x | x | x | x | x | x | x | x | x | x | x | x |
| 408 | x | X | x | x | x | x | x | x | x | x | x | x | x | x | x | x |
| 410 | x | X | x | x | x | x | x | x | x | x | x | x | x | x | x | x |

Table 1 illustrates that each processor of SMP system 402 is coupled to the other processors through each of the switch planes 404, 406, 408 and 410. The uniform switch plane topology illustrated in FIG. 4 illustrates several aspect of interest. First, each processor is coupled to another processor via four routes. If reliability design criteria specify single contingency reliability (at least two routes are required such that upon loss of one route, at least one other route remains), then only two links between any pair of processors is required. The third and fourth routes are not required under a single contingency reliability criteria, and constitute an additional expense (since the third and fourth routes are not required). As will be shown below, a non-uniform SMP system 200 uses at least two links per processor, thereby satisfying a single contingency reliability criteria, while using a smaller N-port crossbar (such as, but not limited to, 12-port or 10-port crossbars). Smaller crossbars correspond to a lower system cost.

TABLE 2

| | Number | 2 Cell | 4 Cell | 8 Cell | 16 Cell |
|---|---|---|---|---|---|
| Number of X- | of Fabric | Bisection | Bisection | Bisection | Bisection |
| Bar Switches | Links | BW (Routes) | BW (Routes) | BW (Routes) | BW (Routes) |
| 4 | 4 * 16 = 64 | 4 | 8 | 16 | 32 |

Table 2 illustrates another aspect of the exemplary uniform switch plane SMP system 402 of FIG. 4. Strong bisectional band width (BW) between processors is provided. A two-cell bisection BW of four routes is provided. That is, the number of routes between any two pairs of processors is four. Furthermore, a four-cell bisection BW of eight routes is provided, an eight-cell bisection BW of sixteen routes is provided, and a sixteen-cell bisection BW of thirty-two routes is provided. Although such bisection BW is very desirable in that traffic congestion and latency are low, such performance comes at a price. Namely, relatively large (and therefore expensive) crossbars are required. As contrasted with various embodiments of non-uniform crossbar switch plane SMP system 200 topologies, smaller crossbars may be used by the various embodiments of the SMP system 200 to save device costs while maintaining acceptable system performance, as measured by overall processing communication speeds (relating to the benefit of single-hop latencies and reduced traffic congestion provided by at least two paths between any pair of processors) and adequate contingency reliability.

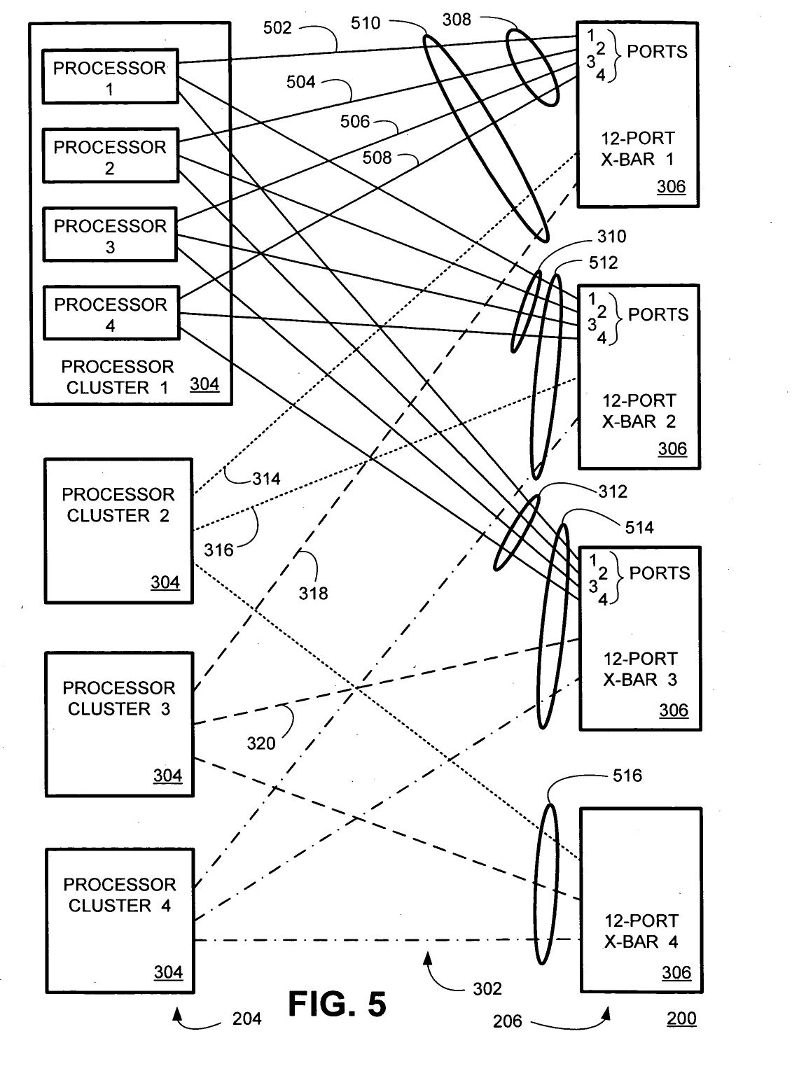

Returning to the embodiment of the SMP system 200 illustrated in FIG. 3, individual links and processors of processor cluster 1 are discussed and contrasted with the above-described uniform switch plane SMP system 402 (FIG. 4). FIG. 5 is a block diagram illustrating greater detail of an exemplary embodiment of a non-uniform switch plane SMP system 200 having sixteen processors and four 12-port crossbars 306. The four processors (labeled as processors 1-4 for convenience) in processor cluster 1 are coupled to the 12-port crossbar 1 (X-bar 1) via link path 308 (see also FIG. 3). As noted above, link path 308 is a group of high-bandwidth point-to-point links 502, 504, 506 and 508. That is, those links associated with the processors of one processor group and associated with the a common crossbar form a link path.

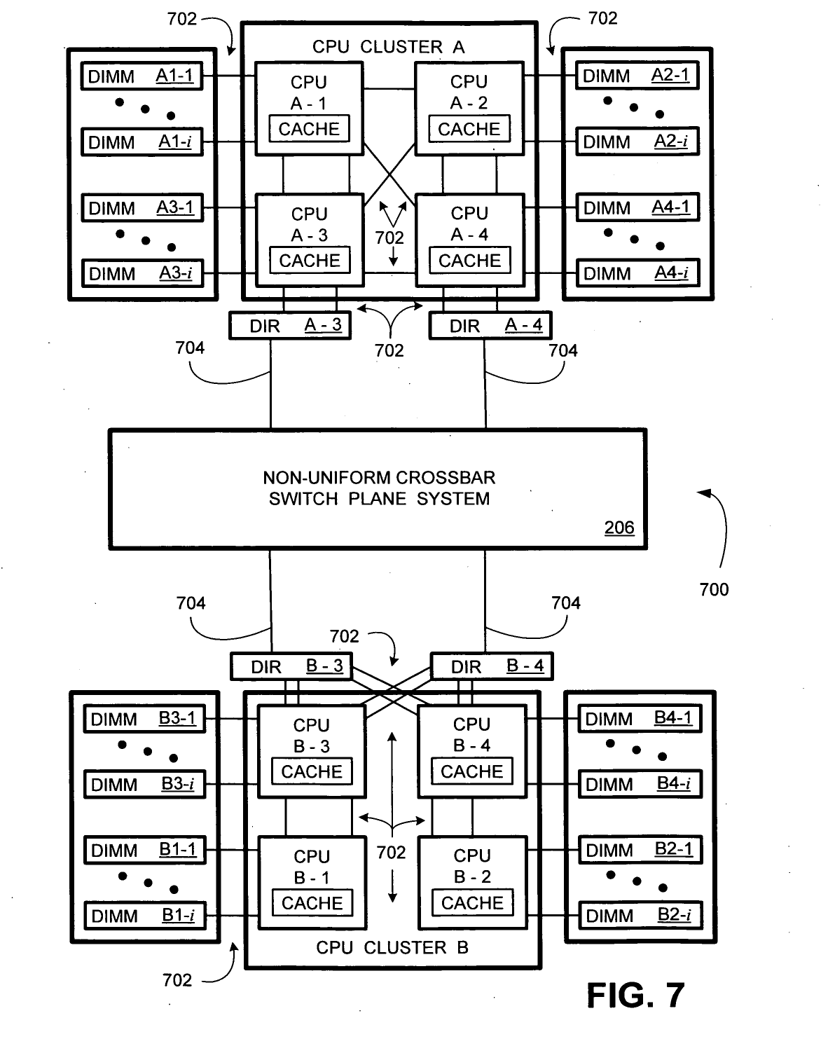

In this exemplary embodiment, individual links from the processors 1-4 are coupled directly to the 12-port crossbars 306. Alternative embodiments may employ intermediary components and/or other topologies (for example, see FIG. 7 and the related discussion below).

Link 502 couples processor 1 to port 1 of the 12-port crossbar 1. As noted above, a link comprises a plurality of lanes, and each lane comprises a plurality of high-speed connections. Accordingly, a port is a plurality of corresponding high-speed pins. Similarly, link 504 couples processor 2 to port 1 of the 12-port crossbar 1, 506 couples processor 3 to port 3 of the 12-port crossbar 1, and 508 couples processor 4 to port 4 of the 12-port crossbar 1. (It is appreciated that the connections to particular crossbar ports are illustrated for convenience, and that port connections may be made in any suitable manner.)

In the exemplary embodiment of SMP 200 illustrated in FIG. 5, non-uniform switch planes couple the processors of three selected processor clusters, via a single 12-port crossbar 306. For example, link path 308 from processor cluster 1, link path 314 (see also FIG. 3) from processor cluster 2, and link path 318 from processor cluster 3, form the non-uniform switch plane 510.

Similarly, the switch plane 512 couples the processors of processor cluster 1, processor cluster 2 and processor cluster 4. Switch plane 514 couples the processors of processor cluster 1, processor cluster 3 and processor cluster 4. Switch plane 516 couples the processors of processor cluster 2, processor cluster 3 and processor cluster 4. Since these non-uniform switch planes 510, 512, 514 and 516 selectively couple the processors of a limited number of processor clusters 304, the switch planes 510, 512, 514 and 516 are referred to as non-uniform switch planes. (See, for contrast, the uniform switch planes illustrated in FIG. 4, where each switch plane couples the processors of all processor cluster to each other.)

Table 3 illustrates connectivity of the processors of SMP system 200 through the four non-uniform switch planes 510, 512, 514 and 516 of FIG. 5. Table 3 illustrates the non-uniformity of connecting routes in that the portions of Table 3 labeled “no connections” indicate that there is no link path from that processor cluster to the corresponding crossbar. For example, in the column associated with processor cluster 1, the four processors (labeled 1-4) have three links (indicated by the “x”) associated with switch planes 510, 512 and 514, and no links associated with the switch plane 516. Accordingly, the four processors of processor cluster 1 are coupled to crossbars 1, 2 and 3, and are not coupled to crossbar 4.

TABLE 3

| Switch | Processor Cluster 1 | | | | Processor Cluster 2 | | | | Processor Cluster 3 | | | | Processor Cluster 4 | | | |
|---|---|---|---|---|---|---|---|---|---|---|---|---|---|---|---|---|
| Plane | 1 | 2 | 3 | 4 | 5 | 6 | 7 | 8 | 9 | 10 | 11 | 12 | 13 | 14 | 15 | 16 |

| | | | | | | | | | | | | | |
|---|---|---|---|---|---|---|---|---|---|---|---|---|---|
| 510 | x | x | x | x | x | x | x | x | x | x | x | x | no connection |

| | | | | | | | | | | | | | |
|---|---|---|---|---|---|---|---|---|---|---|---|---|---|
| 512 | x | x | x | x | x | x | x | x | no connection | x | x | x | x |

| | | | | | | | | | | | | | |
|---|---|---|---|---|---|---|---|---|---|---|---|---|---|
| 514 | x | x | x | x | no connection | x | x | x | x | x | x | x | x |

| | | | | | | | | | | | | | |
|---|---|---|---|---|---|---|---|---|---|---|---|---|---|
| 516 | no connection | x | x | x | x | x | x | x | x | x | x | x | x |

Table 4 illustrates another aspect of the exemplary non-uniform switch plane SMP system 200 of FIG. 5. Strong bisectional BW between processors is provided. A two-cell bisection BW of three routes is provided. That is, the number of routes between any two pairs of processors is three. (Compare with the four route, two-cell bisection BW of the uniform switch plane example of FIG. 4.)

Furthermore, a four-cell bisection BW of six routes is provided, an eight-cell bisection BW of eight routes is provided, and a sixteen-cell bisection BW of twelve routes is provided under the topology of the SMP system 200 illustrated in FIG. 5. As compared to the bisection BW of the uniform switch plane system of FIG. 4, the bisection BW of the exemplary non-uniform switch planes of SMP system 200 illustrated in FIG. 5 provides relatively desirable performance in that traffic congestion and latency are reasonably low. Accordingly, relatively smaller (and therefore less expensive) crossbars may be used. That is, smaller crossbars may be used to save device costs while maintaining acceptable system performance, as measured by overall processing communication speeds (relating to the benefit of single-hop latencies and reduced traffic congestion provided by at least two routes between any pair of processors) and while maintaining adequate contingency reliability.

TABLE 4

| | Number | 2 Cell | 4 Cell | 8 Cell | 16 Cell |
|---|---|---|---|---|---|
| Number of X- | of Fabric | Bisection | Bisection | Bisection | Bisection |
| Bar Switches | Links | BW (Routes) | BW (Routes) | BW (Routes) | BW (Routes) |
| 4 | 4 * 12 = 48 | 3 | 6 | 8 | 12 |

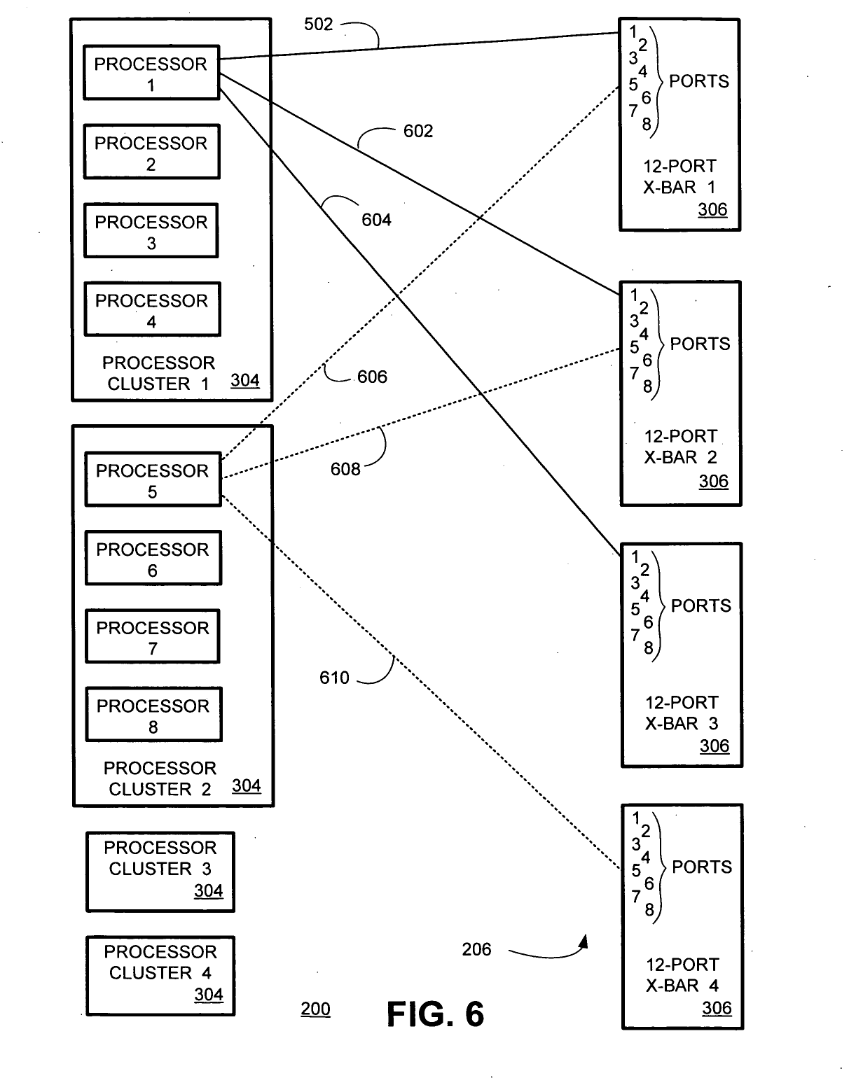

FIG. 6 is a block diagram illustrating greater detail of the exemplary embodiment of a non-uniform switch plane SMP system 200. Here, links from processor 5, residing in processor cluster 2, are illustrated.

Processor 1 is coupled to port 1 of the 12-port crossbar 1 via link 502, as described above. Link 502 is a member of link path 308. Similarly, processor 1 is coupled to port 1 of the 12-port crossbar 2 via link 602, and is coupled to port 1 of the 12-port crossbar 3 via link 604. Link 602 is a member of link path 310 and link 604 is a member of link path 312 (FIGS. 3 and 5). The links 502, 602 and 604 are illustrated as being coupled to port 1 for convenience. Any of the available ports of the 12-port crossbars 306 could be used in alternative embodiments.

Processor 5 is coupled to port 5 of the 12-port crossbar 1, via link 606, as described above. Similarly, processor 5 is coupled to port 5 of the 12-port crossbar 2 via link 608, and is coupled to port 5 of the 12-port crossbar 4 via link 610. The links 606, 608 and 610 are illustrated as being coupled to port 5 for convenience. Any of the available ports of the 12-port crossbars 306 could be used in alternative embodiments.

Processor 1 is therefore communicatively coupled to processor 5 via two routes. The first route is over link 502, through the 12-port crossbar 1, and then over link 606. The second route is over link 602, through the 12-port crossbar 2, and then over link 608. Accordingly, a single contingency criteria is satisfied in that in any one of the above-described links and/or crossbars fails, a route still remains for communications between processor 1 and processor 5. Also, during periods of traffic congestion, one of the two routes may be available for processor-to-processor communications between processor 1 and processor 5 when the other route is not available.

FIG. 7 is a block diagram illustrating selected detail of an alternative embodiment of a non-uniform switch plane SMP system 700. This exemplary alternative embodiment employs intermediary components and/or other topologies.

In this exemplary embodiment, SMP system 700 employs a plurality of processors (identified as CPUs in FIG. 7 for convenience) coupled to input/output (I/O) devices. During fabrication, clusters of processors may be fabricated onto a single die for convenience and efficiency. The exemplary processor clusters A and B each have four processors for illustrative purposes. In this embodiment, the processor cluster A and processor cluster B are coupled to the non-uniform crossbar switch plane system 206 via intermediary components (the directories, described in greater detail below).

Like the exemplary embodiment described above in FIGS. 3, 5 and 6, processor cluster A has four processors (A-1 through A-4). Similarly, processor cluster B has four processors (B-1 through B-4). Each processor has its own cache. The processors (A-1 through A-4, and B-1 through B-4) employ high-bandwidth, point-to-point links 702 to couple to the other processors of the cluster, to directories (DIR), to memory units (illustrated as dual in-line memory modules, DIMMs), and/or I/O devices (not shown). Not shown are other processor clusters coupled to the non-uniform crossbar switch plane system 206.

During the fabrication process of the processor clusters, processors, DIMMs and/or directories may be installed on a common board. A plurality of such modular boards may be installed in a chassis, and coupled to the crossbar system 206 to facilitate communications among the various components. As an individual processor performs an operation that determines a new value of information, it stores a working version of the determined new information into its cache. The processor, at some point during the operation, may store the determined new information into its respective DIMM, or into another DIMM, depending upon the circumstances of the operation being performed by the processor. Accordingly, processor A-1 may store information directly into its cache or DIMMs A1-1 through A1-i. Other processors, similarly illustrated, have their own caches and are also coupled to their own DIMMs. For example, processor B-3 may store information into its cache and/or into DIMMs B3-1 through B3-i.

The above-described processors are coupled to the external directories (DIR), via the high-bandwidth, point-to-point links 702. The directories are memory-based devices that are responsible for tracking information that is cached by processors in other processor clusters. For example, DIR A-3 tracks information in DIMMs associated with the processors of processor cluster A. Directories coordinate the determination of where information is stored.

In this exemplary embodiment, the directories are coupled together through crossbar system 206, via connections 704. As noted above, crossbar system 206 is a plurality of individual crossbars (not shown) coupled to each other in any suitable non-uniform switch plane topology. It is appreciated that the topology of the above-described SMP system 700 is very simplistic. Furthermore, many different topologies for connecting components of the processor cluster may be used. For example, the topology of processor cluster A is illustrated differently from the topology of processor cluster B to indicate the diversity of possible processor cluster topologies. Also, I/O devices may be included and/or may replace processors of any of the cluster topologies. SMP system 700 may employ many processor clusters. Such processor clusters may have more than, or fewer than, the four processors illustrated in processor clusters A and B. The coupling of the directories (DIR) to their respective processors, and the coupling to the crossbar system 206, may also vary. Accordingly, the simplified exemplary SMP system 700 of FIG. 7 is an illustrative generic SMP system embodiment that is representative of the possible SMP embodiment topologies.

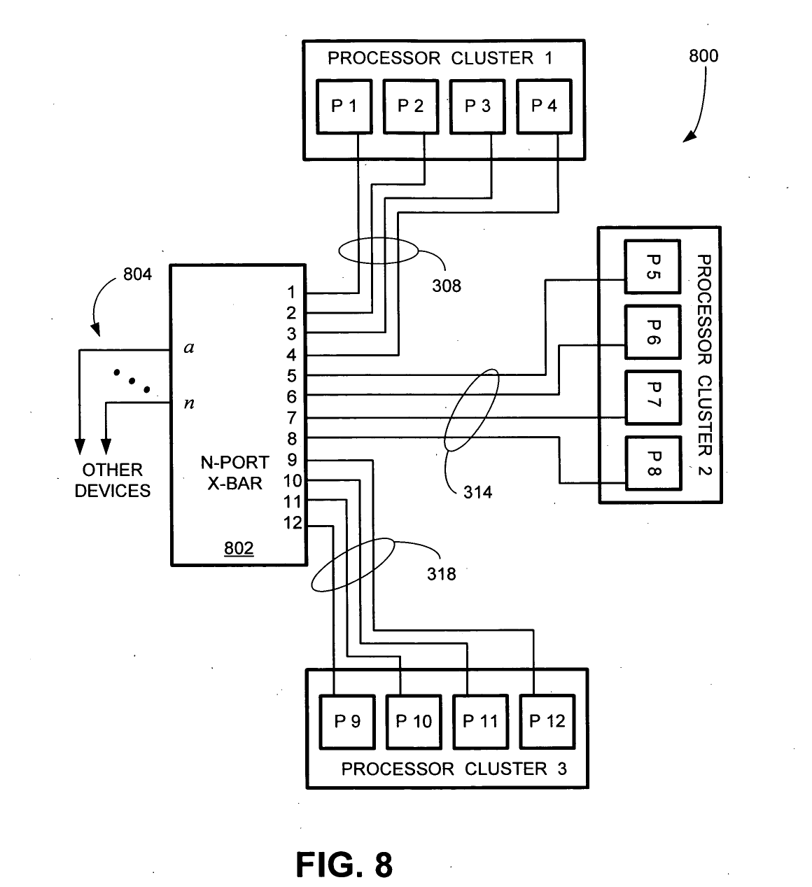

FIG. 8 is a block diagram of a portion of an alternative embodiment of an SMP system 800 illustrating an N-port crossbar 802 that provides for additional links for communicatively coupling to input/output (I/O) devices and/or to other crossbars. Here, the illustrative embodiment of FIG. 8 generally corresponds to the above-described embodiments illustrated in FIGS. 3 and 5-6. Accordingly, there are twelve ports 1-12 that couple to the links of link paths 308, 314 and 318, thereby providing connectivity to the processors P1-P4 of the processor cluster 1, with the processors P5-P8 of processor cluster 2, and the processors P9-P12 of processor cluster 3. The ports a-n, coupled to links 804, provide for coupling to other devices, such as I/O devices and/or memory devices. Since only a portion of the SMP system 800 is illustrated in FIG. 8, it is appreciated that there are three other N-port crossbars and processor cluster 4 that are not shown such that the topology of the SMP system 800 generally corresponds to the above described non-uniform crossbar switch plane topologies illustrated in FIGS. 3 and 5-6.

FIGS. 3 and 5-8 illustrate exemplary topologies of non-uniform crossbar switch plane SMP system embodiments. It is appreciated that the variations in topologies of the non-uniform crossbar switch plane SMP system embodiments are nearly limitless, and that the above-described embodiments generally illustrate and teach the principles of a non-uniform crossbar switch plane in a SMP system embodiment. To further describe possible alternative embodiments, a selected number of alternative embodiments are described hereinbelow.

Tables 5a and 5b illustrate connectivity of the processors of an exemplary SMP system embodiment that has five processor clusters, each processor cluster having three processors. Here, fifteen processors are coupled together in a non-uniform crossbar switch plane topology. Five 12-port crossbars are used by this exemplary embodiment. Table 5a illustrates the non-uniformity of connecting routes in that the portions of Table 5a labeled “no connection” indicate that there is no link path from that processor cluster to the corresponding crossbar.

TABLE 5a

| Switch | Processor Cluster 1 | | | Processor Cluster 2 | | | Processor Cluster 3 | | | Processor Cluster 4 | | | Processor Cluster 5 | | |
|---|---|---|---|---|---|---|---|---|---|---|---|---|---|---|---|
| Plane | 1 | 2 | 3 | 4 | 5 | 6 | 7 | 8 | 9 | 10 | 11 | 12 | 13 | 14 | 15 |

| | | | | | | | | | | | | | |
|---|---|---|---|---|---|---|---|---|---|---|---|---|---|
| 0 | no connection | x | x | x | x | x | x | x | x | x | x | x | x |

| | | | | | | | | | | | | | |
|---|---|---|---|---|---|---|---|---|---|---|---|---|---|
| 1 | x | x | x | no connection | x | x | x | x | x | x | x | x | x |

| | | | | | | | | | | | | | |
|---|---|---|---|---|---|---|---|---|---|---|---|---|---|
| 2 | x | x | x | x | x | x | no connection | x | x | x | x | x | x |

| | | | | | | | | | | | | | |
|---|---|---|---|---|---|---|---|---|---|---|---|---|---|
| 3 | x | x | x | x | x | x | x | x | x | no connection | x | x | x |

| | | | | | | | | | | | | | |
|---|---|---|---|---|---|---|---|---|---|---|---|---|---|
| 4 | x | x | x | x | x | x | x | x | x | x | x | x | no connection |

Table 5b illustrates aspects of this exemplary non-uniform switch plane SMP system embodiment. Strong bisectional BW between processors is provided. A two-cell bisection BW of four routes is provided. That is, the number of routes between any two pairs of processors is four. (Compare with the 4 route, two-cell bisection BW of the uniform switch plane example of FIG. 4). Furthermore, a three-cell bisection BW of six routes is provided, a six-cell bisection BW of nine routes is provided, a twelve-cell bisection BW of eighteen routes is provided, and a fifteen-cell bisection BW of thirty routes is provided under the exemplary topology of Tables 5a and 5b.

TABLE 5b

| | Number | 2 Cell | 3 Cell | 6 Cell | 12 Cell | 15 Cell |
|---|---|---|---|---|---|---|
| Number of X- | of Fabric | Bisection | Bisection | Bisection | Bisection | Bisection |
| Bar Switches | Links | BW (Routes) | BW (Routes) | BW (Routes) | BW (Routes) | BW (Routes) |
| 5 | 5*12 = 60 | 4 | 6 | 9 | 18 | 30 |

Tables 6a and 6b illustrate connectivity of the processors of an exemplary SMP system embodiment that has three processor clusters, each processor cluster having five processors. Here, fifteen processors are coupled together in a non-uniform crossbar switch plane topology. Six 10-port crossbars are used by this exemplary embodiment. Table 6a illustrates the non-uniformity of connecting routes in that the portions of Table 6a labeled “no connection” indicate that there is no link path from that processor cluster to the corresponding crossbar.

TABLE 6a

| Switch | Processor Cluster A | | | | | Processor Cluster B | | | | | Processor Cluster C | | | | |
|---|---|---|---|---|---|---|---|---|---|---|---|---|---|---|---|
| Plane | 1 | 2 | 3 | 4 | 5 | 6 | 7 | 8 | 9 | 10 | 11 | 12 | 13 | 14 | 15 |

| | | | | | | | | | | | |
|---|---|---|---|---|---|---|---|---|---|---|---|
| 0 | no connection | x | x | x | x | x | x | x | x | x | x |

| | | | | | | | | | | | |
|---|---|---|---|---|---|---|---|---|---|---|---|
| 1 | x | x | x | x | x | no connection | x | x | x | x | x |

| | | | | | | | | | | | |
|---|---|---|---|---|---|---|---|---|---|---|---|
| 2 | x | x | x | x | x | x | x | x | x | x | no connection |

| | | | | | | | | | | | |
|---|---|---|---|---|---|---|---|---|---|---|---|
| 3 | no connection | x | x | x | x | x | x | x | x | x | x |

| | | | | | | | | | | | |
|---|---|---|---|---|---|---|---|---|---|---|---|
| 4 | x | x | x | x | x | no connection | x | x | x | x | x |

| | | | | | | | | | | | |
|---|---|---|---|---|---|---|---|---|---|---|---|
| 5 | x | x | x | x | x | x | x | x | x | x | no connection |

Table 6b illustrates aspects of this exemplary non-uniform switch plane SMP system embodiment. Strong bisectional BW between processors is provided. A two-cell bisection BW of four routes is provided. That is, the number of routes between any two pairs of processors is four. Furthermore, a five-cell bisection BW of ten routes is provided, a ten-cell bisection BW of ten routes is provided, and a fifteen-cell bisection BW of thirty routes is provided under the exemplary topology of Tables 6a and 6b.

TABLE 6b

| | Number | 2 Cell | 5 Cell | 10 Cell | 15 Cell |
|---|---|---|---|---|---|
| Number of X- | of Fabric | Bisection | Bisection | Bisection | Bisection |
| Bar Switches | Links | BW (Routes) | BW (Routes) | BW (Routes) | BW (Routes) |
| 6 | 6 * 10 = 60 | 4 | 10 | 10 | 30 |

Tables 7a and 7b illustrate connectivity of the processors of an exemplary SMP system embodiment that has six processor clusters, each processor cluster having three processors. Here, eighteen processors are coupled together in a non-uniform crossbar switch plane topology. Six 12-port crossbars are used by this exemplary embodiment. Table 7a illustrates the non-uniformity of connecting routes in that the portions of Table 7a labeled “no connection” indicate that there is no link path from that processor cluster to the corresponding crossbar.

TABLE 7a

| Switch | Processor Cluster A | | | Processor Cluster B | | | Processor Cluster C | | | Processor Cluster D | | | Processor Cluster E | | | Processor Cluster F | | |
|---|---|---|---|---|---|---|---|---|---|---|---|---|---|---|---|---|---|---|
| Plane | 1 | 2 | 3 | 4 | 5 | 6 | 7 | 8 | 9 | 10 | 11 | 12 | 13 | 14 | 15 | 16 | 17 | 18 |

| | | | | | | | | | | | | | | |
|---|---|---|---|---|---|---|---|---|---|---|---|---|---|---|
| 0 | x | x | x | x | x | x | x | x | x | no connection | x | x | x | no connection |

| | | | | | | | | | | | | | | |
|---|---|---|---|---|---|---|---|---|---|---|---|---|---|---|
| 1 | x | x | x | x | x | x | no connection | x | x | x | no connection | x | x | x |

| | | | | | | | | | | | | | | |
|---|---|---|---|---|---|---|---|---|---|---|---|---|---|---|
| 2 | x | x | x | no connection | x | x | x | x | x | x | x | x | x | no connection |

| | | | | | | | | | | | | | | |
|---|---|---|---|---|---|---|---|---|---|---|---|---|---|---|
| 3 | no connection | x | x | x | x | x | x | x | x | x | no connection | x | x | x |

| | | | | | | | | | | | | | | |
|---|---|---|---|---|---|---|---|---|---|---|---|---|---|---|
| 4 | x | x | x | no connection | x | x | x | no connection | x | x | x | x | x | x |

| | | | | | | | | | | | | | |
|---|---|---|---|---|---|---|---|---|---|---|---|---|---|
| 5 | no connection | x | x | x | no connection | x | x | x | x | x | x | x | x |

Table 7b illustrates aspects of this exemplary non-uniform switch plane SMP system embodiment. Strong bisectional BW between processors is provided. A two-cell bisection BW of four routes is provided. That is, the number of links between any two pairs of processors is four. Furthermore, a three-cell bisection BW of six routes is provided, a six-cell bisection BW of six routes is provided, a nine-cell bisection BW of nine routes is provided, and an eighteen-cell bisection BW of thirty routes is provided under the exemplary topology of Tables 7a and 7b.

TABLE 7b

| | Number | 2 Cell | 3 Cell | 6 Cell | 9 Cell | 18 Cell |
|---|---|---|---|---|---|---|
| Number of X- | of Fabric | Bisection | Bisection | Bisection | Bisection | Bisection |
| Bar Switches | Links | BW (Routes) | BW (Routes) | BW (Routes) | BW (Routes) | BW (Routes) |
| 6 | 6*12 = 72 | 4 | 6 | 6 | 9 | 30 |

Tables 8a and 8b illustrate connectivity of the processors of an exemplary SMP system embodiment that has eight processor clusters, each processor cluster having two processors. Here, sixteen processors are coupled together in a non-uniform crossbar switch plane topology. Eight 10-port crossbars are used by this exemplary embodiment. Table 8a illustrates the non-uniformity of connecting routes in that the portions of Table 8a labeled “no connection” indicate that there is no link path from that processor cluster to the corresponding crossbar. In this example, crossbars 0 through 3 provide strong bisection bandwidth between “Even” processor clusters A through D but weaker bisection bandwidth between “Even” and “Odd” clusters, while crossbars 4 through 7 provide strong bisection bandwidth between “Odd” processor clusters E through H, but weaker bisection bandwidth between “Even” and “Odd” clusters. This example illustrates that non-uniform crossbar system embodiments may be designed to provision asymmetric bisection bandwidths among the processor groups as desired. Accordingly, SMP systems that are normally “Partitioned” (via hardware and/or software methods) into groups of processor clusters can optimize overall performance using various non-uniform crossbar system embodiments.

TABLE 8a

| | “Even” Processor Clusters | | | | | | | | “Odd” Processor Clusters | | | | | | | |
|---|---|---|---|---|---|---|---|---|---|---|---|---|---|---|---|---|
| Switch | Cluster A | | Cluster B | | Cluster C | | Cluster D | | Cluster E | | Cluster F | | Cluster G | | Cluster H | |
| Plane | 1 | 2 | 3 | 4 | 5 | 6 | 7 | 8 | 9 | 10 | 11 | 12 | 13 | 14 | 15 | 16 |
| 0 | x | X | x | x | x | x | x | x | x | x | | | | | | |
| 1 | x | X | x | x | x | x | x | x | | | x | x | | | | |
| 2 | x | X | x | x | x | x | x | x | | | | | x | x | | |
| 3 | x | X | x | x | x | x | x | x | | | | | | | x | x |
| 4 | x | X | | | | | | | x | x | x | x | x | x | x | x |

| | | | | | | | | | | | | | | | |
|---|---|---|---|---|---|---|---|---|---|---|---|---|---|---|---|
| 5 | no connection | x | x | | | | | x | x | x | x | x | x | x | x |
| 6 | no connection | | | x | x | | | x | x | x | x | x | x | x | x |
| 7 | no connection | | | | | x | x | x | x | x | x | x | x | x | x |

Table 8b illustrates aspects of this exemplary non-uniform switch plane SMP system embodiment. Strong bisectional BW between processors within Even and Odd clusters is provided, with lesser bisection BW between Even and Odd clusters (though still meeting 1-hop and at least 2 route requirements). A two-cell bisection BW of five links is provided within Even and Odd clusters, and a bisection BW of two links is provided between Even and Odd clusters. That is, the number of links between any two pairs of processors is five or two. Furthermore, a four-cell bisection BW of eight routes is provided within Even and Odd clusters, and a bisection BW of four links is provided between Even and Odd clusters, an eight-cell bisection BW of sixteen routes is provided within Even and Odd clusters, and a bisection BW of eight links is provided between Even and Odd clusters, and a sixteen-cell bisection BW of sixteen routes is provided under the exemplary topology of Tables 8a and 8b.

TABLE 8b

| | Number | 2 Cell | 4 Cell | 8 Cell | 16 Cell |
|---|---|---|---|---|---|
| Number of X- | of Fabric | Bisection | Bisection | Bisection | Bisection |
| Bar Switches | Links | BW (Routes) | BW (Routes) | BW (Routes) | BW (Routes) |
| 8 | 8 * 10 = 80 | | | | |
| | Within | 5 | 8 | 16 | N/A |
| | Even/Odd | | | | |
| | Between | 2 | 4 | 8 | 16 |
| | Even/Odd | | | | |

The exemplary embodiments of Tables 5a-b, 6a-b, 7a-b and 8a-b illustrate the great flexibility is selecting a particular non-uniform crossbar switch plane topology to meet the particular needs of the SMP system embodiment. For example, the use of ten and twelve port crossbars were illustrated. It is appreciated that any suitable N-port crossbar may be used in a SMP embodiment. Furthermore, the number of processors in a processor cell may vary, as illustrated by the above-described tables. It is appreciated that any suitable number of processors in a processor cluster may vary in SMP embodiments.

The above-described embodiments illustrated in FIGS. 3 and 5-8 provided for two routes between any two processors to satisfy the single contingency design criteria. Thus, when compared to the uniform crossbar switch plane topology illustrated in FIG. 4, which provided for four routes between processors, it is appreciated that the number of crossbars and the number of links required to implement the above-described embodiment was reduced. However, under other design criteria, it may be desirable to provide for three or more routes between processors using a non-uniform crossbar switch plane SMP system embodiment. For example, the topology illustrated by Tables 5a-b provided for three routes. Three routes provide for a double contingency reliability criteria. That is, two routes could be unavailable (due to failure or traffic congestion), and a third alternative route remains.

At its highest level, an embodiment of a non-uniform crossbar switch plane SMP system embodiment communicatively couples a plurality of processor groups via a plurality of crossbars and a plurality of link paths, where one link path couples one of the processor groups uniquely with one of the crossbars. Thus, a plurality of routes are defined where each route comprises of one of the crossbars and two of the link paths. Accordingly, two processor groups are communicatively coupled together via one route (their associated link paths and the intervening crossbar). Non-uniformity is realized when the number of routes is equal to N-1, where N equals the number of processor groups. Accordingly, in an SMP system having four processor groups, one embodiment communicatively couples the four processor groups to each other via three routes. Another embodiment communicatively couples the four processor groups to each other via two routes.

As another non-limiting example, in an SMP system having ten processor groups, one embodiment communicatively couples the ten processor groups via nine routes. Other embodiments communicatively couple the ten processor groups to each other via eight routes, via seven routes, via six routes, via five routes, via four routes, via three routes, or via two routes.

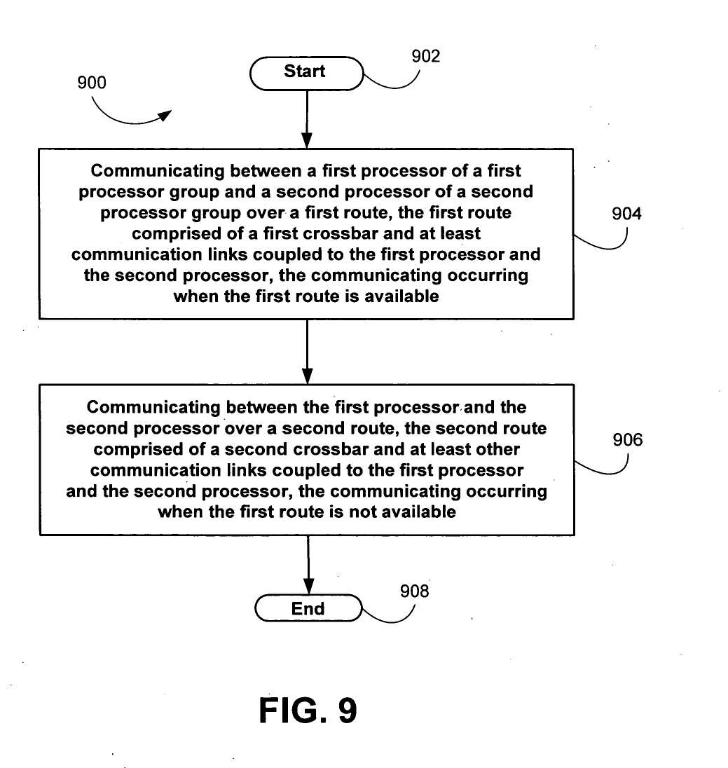

FIG. 9 is a flowchart 900 illustrating an embodiment of a process for processor-to-processor communications in a symmetric multiprocessing (SMP) system having a plurality of processor groups. Alternative embodiments implement the processes of flowchart 900 with hardware configured as a state machine. All such modifications and variations are intended to be included herein within the scope of this disclosure.

The process of flow chart 900 begins at block 902. At block 904, a first processor of a first processor group and a second processor of a second processor group over a first route communicate, the first route comprised of a first crossbar and at least communication links coupled to the first processor and the second processor, the communicating occurring when the first route is available. At block 906, the first processor and the second processor communicate over a second route, the second route comprised of a second crossbar and at least other communication links coupled to the first processor and the second processor, the communicating occurring when the first route is not available. As noted herein above, each of the processor groups are coupled to the other processor groups by a number of routes at most equal to (N-1), where N equals the number of processor groups. The process ends at block 908.

It should be emphasized that the above-described embodiments are merely examples of the disclosed system and method. Many variations and modifications may be made to the above-described embodiments. All such modifications and variations are intended to be included herein within the scope of this disclosure.

What is claimed is:

1. A symmetric multiprocessing (SMP) system, comprising:
a plurality of processor groups; and
a non-uniform crossbar switch plane system comprising a plurality of routes,
such that each of the processor groups are communicatively coupled to the other processor groups by a number of routes at most equal to (N-1), where N equals the number of processor groups.

2. The SMP system of claim 1, further comprising:
a plurality of processors residing in each processor group; and
a plurality of communication links,
wherein one link uniquely communicatively couples one processor with one of a plurality of crossbars, and wherein those links associated with the processors of one processor group and the associated crossbar form a link path, and wherein a route is between a pair of processor groups is comprised of the link paths associated with the paired processor groups and the crossbar that the link paths are coupled to.

3. The SMP system of claim 1, wherein each of the processor groups are coupled to their respective routes via intermediary directories.

4. A non-uniform crossbar switch plane system, comprising:
a first crossbar coupled only to:
a first group of processors;
a second group of processors; and
a third group of processors;
second crossbar coupled only to:
the first group of processors;
the second group of processors; and
a fourth group of processors;
a third crossbar coupled only to:
the first group of processors;
the third group of processors; and
the fourth group of processors, and
a fourth crossbar coupled only to:
the second group of processors;
the third group of processors; and
the fourth group of processors.

5. The non-uniform crossbar switch plane system of claim 4,
wherein a plurality of first processors residing in the first processor group may communicate with a plurality of second processors residing in the second processor group through the first crossbar and the second crossbar,
wherein the plurality of first processors may communicate with a plurality of third processors residing in the third processor group through the first crossbar and the third crossbar,
wherein the plurality of first processors may communicate with a plurality of fourth processors residing in the fourth processor group through the second crossbar and the third crossbar,
wherein the plurality of second processors may communicate with the plurality of third processors through the first crossbar and the fourth crossbar,
wherein the plurality of second processors may communicate with the plurality of fourth processors through the second crossbar and the fourth crossbar, and
wherein the plurality of third processors may communicate with the plurality of fourth processors through the third crossbar and the fourth crossbar.

6. The non-uniform crossbar switch plane system of claim 4, wherein the first crossbar, the second crossbar, the third crossbar and the fourth crossbar are further configured to couple to at least one other remote device.

7. A non-uniform crossbar switch plane system, comprising:
a plurality of crossbars;
a plurality of processor groups;
a plurality of link paths, one link path communicatively coupling one of the processor groups uniquely with one of the crossbars; and
a plurality of routes, each route comprising of one of the crossbars and two of the link paths coupled to that crossbar, such that the processor groups associated with the two link paths are communicatively coupled together,
wherein each of the processor groups are coupled to the other processor groups by a number of routes at most equal to (N-1), where N equals the number of processor groups.

8. The non-uniform crossbar switch plane system of claim 7, wherein each of the processor groups further comprises a plurality of processors.

9. The non-uniform crossbar switch plane system of claim 8, wherein each of the processor groups further comprises an equal number of the processors.

10. The non-uniform crossbar switch plane system of claim 8, wherein at least one of the processor groups further comprises at least one device such that the number of devices and processors equals the number of the plurality of processors of the other processor groups.

11. The non-uniform crossbar switch plane system of claim 7, wherein only two routes communicatively couple any two pairs of processor groups.

12. The non-uniform crossbar switch plane system of claim 7, wherein only three routes communicatively couple any two pairs of processor groups.

13. The non-uniform crossbar switch plane system of claim 7, further comprising:
a plurality of communication links, each link uniquely a member of one of the link paths; and
a plurality of processors residing in each of the processor groups, each processor having at least a number of the communication links equal to (N-1), such that each processor is communicatively coupled to those crossbars to which its processor group is coupled to.

14. The non-uniform crossbar switch plane system of claim 13, wherein each of the communication links is a high-bandwidth point-to-point link.

15. The non-uniform crossbar switch plane system of claim 13, wherein at least one of the processors are configured to also couple to at least one other remote device.

16. The non-uniform crossbar switch plane system of claim 7, wherein at least one of the crossbars is further configured to couple to at least one other remote device.

17. The non-uniform crossbar switch plane system of claim 7, further comprising a symmetric multiprocessing (SMP) system wherein the plurality of crossbars, the plurality of processor groups, the plurality of link paths and the plurality of routes reside.

18. The non-uniform crossbar switch plane system of claim 7, further comprising a plurality of directories associated with at least one of the processor groups, and wherein the directories are communicatively coupled between the link paths and the processor group, and wherein that processor group is not coupled to the link paths, such that the directories and the other processor groups are communicatively coupled by a number of routes at most equal to (N-1), where N equals the number of processor groups.

19. The non-uniform crossbar switch plane system of claim 7, wherein each of the processor groups further comprises a plurality of processors and wherein the processors of that processor group are communicatively coupled to the directories instead of to the link paths.

20. A method for processor-to-processor communications in a symmetric multiprocessing (SMP) system having a plurality of processor groups, comprising:
communicating between a first processor of a first processor group and a second processor of a second processor group over a first route, the first route comprised of a first crossbar and at least communication links coupled to the first processor and the second processor, the communicating occurring when the first route is available; and
communicating between the first processor and the second processor over a second route, the second route comprised of a second crossbar and at least other communication links coupled to the first processor and the second processor, the communicating occurring when the first route is not available;
wherein each of the processor groups are coupled to the other processor groups by a number of routes at most equal to (N-1), where N equals the number of processor groups.

21. The method of claim 20, wherein the first route is not available because of a failure in the first route.

22. The method of claim 20, wherein the first route is not available because of traffic congestion in the first route.

23. A symmetric multiprocessing (SMP) system having a plurality of processor groups:
means for communicatively coupling the plurality of processor groups to each other via a plurality of routes;
means for communicating between a first processor of a first processor group and a second processor of a second processor group over a first route, the first route comprised of a first crossbar and at least communication links coupled to the first processor and the second processor, the communicating occurring when the first route is available; and
means for communicating between the first processor and the second processor over a second route, the second route comprised of a second crossbar and at least other communication links coupled to the first processor and the second processor, the communicating occurring when the first route is not available;
wherein each of the processor groups are coupled to the other processor groups by a number of routes at most equal to (N-1), where N equals the number of processor groups.
